(19) United States
(12) Patent Application Publication
(10) Pub. No.: US 2016/0195760 A1
(43) Pub. Date: Jul. 7, 2016

(54) LIQUID CRYSTAL DISPLAY APPARATUS

(71) Applicant: SAMSUNG DISPLAY CO., LTD., Yongin-Si (KR)

(72) Inventors: Hyeongu CHO, Yongin-si (KR); Gakseok LEE, Yongin-si (KR); Sunkyu JOO, Yongin-si (KR)

(21) Appl. No.: 14/973,607

(22) Filed: Dec. 17, 2015

(30) Foreign Application Priority Data
Jan. 2, 2015 (KR) 10-2015-0000292

(51) Int. Cl. G02F 1/1335

(52) U.S. Cl. CPC G02F 1/133512; G02F 1/133524; G02F 1/133603; G02F 1/133528; G02F 1/133514; G02F 2001/133548

(57) ABSTRACT

A liquid crystal display (LCD) apparatus capable of displaying an image at a constant light intensity is provided. The LCD apparatus includes a substrate including a first surface and a second surface opposite to the first surface; a plurality of pixel electrodes disposed on the first surface of the substrate; a plurality of light-shielding layers disposed corresponding to first locations between the pixel electrodes; a plurality of light sources corresponding to the light-shielding layers, wherein the light sources are configured to irradiate light onto the second surface of the substrate; and a transparent light guide panel disposed between the light sources and the substrate.

### RELATED APPLICATION

This application claims the benefit of Korean Patent Application No. 10-2015-0000292 filed on Jan. 2, 2015 in the Korean Intellectual Property Office, the disclosure of which is incorporated herein in its entirety by reference.

### BACKGROUND

1. Technical Field

The present disclosure generally relates to a liquid crystal display apparatus, and more particularly, to a see-through liquid crystal display apparatus.

2. Description of the Related Art

With the recent developments in various electronic devices such as mobile phones, computers, large-screen TVs, etc., the demand for flat panel display devices that may be used in those electronic devices has also increased. Among the different types of flat panel display devices, a liquid crystal display (LCD) has the following advantages: low power consumption, easy display of dynamic images, a high contrast ratio, etc.

Recently, research into a see-through LCD apparatus has been conducted. A user can observe an image implemented by an LCD, as well as an external background, on a see-through LCD apparatus.

The see-through LCD apparatus includes a liquid crystal layer disposed between two substrates. A transmittance difference is achieved by changing a direction in which liquid crystal molecules in the liquid crystal layer are arranged after an electric field is applied to the liquid crystal layer. Since the see-through LCD apparatus cannot emit light on its own, the see-through LCD therefore requires a light source for irradiating light onto a display panel.

However, in a conventional see-through LCD apparatus, a contrast ratio of the display panel may vary in different spots depending on the locations and number of light-irradiating sources.

### SUMMARY

The present disclosure addresses at least the above issues relating to the contrast ratio in a see-through LCD apparatus.

According to one or more exemplary embodiments of the inventive concept, a liquid crystal display (LCD) apparatus is provided. The LCD apparatus includes: a substrate including a first surface and a second surface opposite to the first surface; a plurality of pixel electrodes disposed on the first surface of the substrate; a plurality of light-shielding layers disposed corresponding to first locations between the pixel electrodes; a plurality of light sources corresponding to the light-shielding layers, wherein the light sources are configured to irradiate light onto the second surface of the substrate; and a transparent light guide panel disposed between the light sources and the substrate.

In some embodiments, each of the light sources may include an organic light-emitting diode (OLED).

In some embodiments, the OLED may include: a first electrode; a second electrode; and an intermediate layer disposed between the first electrode and the second electrode, wherein the intermediate layer is configured to emit white light.

In some embodiments, the LCD apparatus may further include a plurality of color filters disposed opposite to the substrate, wherein the pixel electrodes are disposed between the color filters and the substrate. The light-shielding layers may be disposed between the color filters.

In some embodiments, an area of each of the light sources may be less than or equal to an area of each of the light-shielding layers.

In some embodiments, the light sources may be disposed on second locations corresponding to the light-shielding layers in a mesh form.

In some embodiments, the light sources may be disposed on second locations corresponding to the light-shielding layers in an island form.

In some embodiments, the LCD apparatus may further include a polarizer disposed between the substrate and the light guide panel.

In some embodiments, the LCD apparatus may further include a polarizer disposed between the light guide panel and the light sources. The polarizer may be patterned corresponding to the light sources.

In some embodiments, the polarizer may be a wire-grid polarizer (WGP).

In some embodiments, the light guide panel and the light sources may be flexible.

### BRIEF DESCRIPTION OF THE DRAWINGS

The above and other aspects of the inventive concept will be apparent in view of the following description of exemplary embodiments taken in conjunction with the accompanying drawings.

FIG. 1 is a schematic cross-sectional view of a liquid crystal display (LCD) apparatus according to an exemplary embodiment.

FIG. 2 is a schematic cross-sectional view of the light sources of the LCD apparatus of FIG. 1.

FIG. 3 is a schematic plan view of the LCD apparatus of FIG. 1.

FIG. 4 is a schematic bottom view of the light guide panel and light sources of the LCD apparatus of FIG. 3.

FIG. 5 is a schematic bottom view of a light guide panel and light sources of an LCD apparatus according to another exemplary embodiment.

FIG. 6 is a schematic cross-sectional view of an LCD apparatus according to another exemplary embodiment.

### DETAILED DESCRIPTION

As the inventive concept allows for various changes and numerous exemplary embodiments, particular exemplary embodiments will be illustrated in the drawings and described in detail in the written description. The attached drawings for illustrating exemplary embodiments of the inventive concept are referred to in order to gain a sufficient understanding of the inventive concept, the merits thereof, and the objectives accomplished by the implementation of the inventive concept. The inventive concept may, however, be embodied in many different forms and should not be construed as being limited to the exemplary embodiments set forth herein.

The inventive concept will be described herein in detail by describing exemplary embodiments of the inventive concept with reference to the attached drawings. Like reference numerals in the drawings denote like elements, and a detailed description of those like elements will be omitted.

While such terms as “first”, “second”, etc., may be used to describe various components, those components are not limited by the above terms. Rather, the above terms are merely used to distinguish one component from another.

It will be understood that when a layer, region, or component is referred to as being formed “on” or “above” another layer, region, or component, it can be directly or indirectly formed on or above the other layer, region, or component. In some instances, for example, intervening layers, regions, or components may be present.

Sizes of components in the drawings may be exaggerated for convenience of explanation. In other words, since sizes and thicknesses of components in the drawings are arbitrarily illustrated for convenience of explanation, the following exemplary embodiments are not limited thereto.

In the following examples, the x-axis, the y-axis and the z-axis are not limited to three axes of the rectangular coordinate system, and may be interpreted in a broader sense. For example, the x-axis, the y-axis, and the z-axis may be perpendicular to one another, or may represent different directions that are not perpendicular to one another.

The embodiments may be implemented in different ways and the process order for some embodiments may be performed differently from the described order. For example, two or more processes may be performed substantially at the same time or performed in an order opposite to the described order.

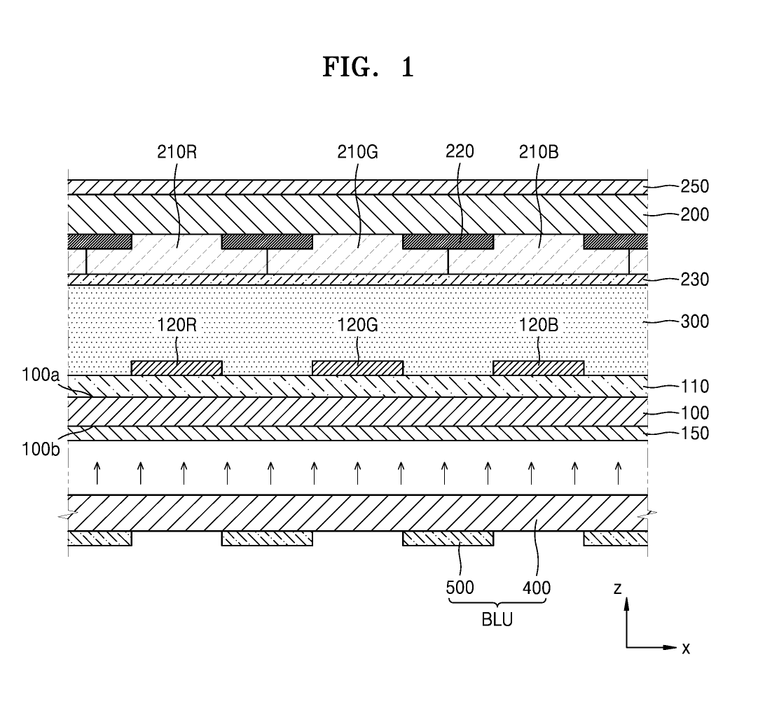

FIG. 1 is a schematic cross-sectional view of a liquid crystal display (LCD) apparatus according to an exemplary embodiment.

Referring to FIG. 1, the LCD apparatus includes a substrate 100, a plurality of pixel electrodes 120R, 120G, and 120B, a plurality of light-shielding layers 220, a transparent light guide panel 400, and a plurality of light sources 500.

The substrate 100 may have a first surface 100a and a second surface 100b opposite to the first surface 100a. The substrate 100 is transparent, and may be a glass substrate or a substrate including a polymer (such as polyimide).

A plurality of display devices are disposed on the first surface 100a of the substrate 100. As shown in FIG. 1, the display devices may be liquid crystal devices in which a liquid crystal 300 is disposed between the pixel electrodes 120R, 120G, and 120B and a common electrode 230. The pixel electrodes 120R, 120G, and 120B and the common electrode 230 may include transparent materials such as indium tin oxide (ITO), indium zinc oxide (IZO), zinc oxide (ZnO), or indium oxide (In₂O₃) which impart transparency characteristics. Since the pixel electrodes 120R, 120G, and 120B are electrically connected to thin film transistors (TFTs), a TFT layer 110 may be disposed between the substrate 100 and the pixel electrodes 120R, 120G, and 120B.

The exemplary embodiment of FIG. 1 may be modified in different ways. For example, in some embodiments, an alignment layer may be further disposed on the pixel electrodes 120R, 120G, and 120B, and/or the common electrode 230.

Color filters (for example, red, green, and blue color filters 210R, 210G, and 210B) may be disposed opposite to the substrate 100 such that the pixel electrodes 120R, 120G, and 120B are disposed therebetween. The red, green, and blue color filters color filters 210R, 210G, and 210B may correspond to the pixel electrodes 120R, 120G, and 120B, respectively. That is, the red color filter 210R may correspond to the pixel electrode 120R having a red sub-pixel, the green color filter 210G may correspond to the pixel electrode 120G having a green sub-pixel, and the blue color filter 210B may correspond to the pixel electrode 120B having a blue sub-pixel. Accordingly, the display devices are disposed between the substrate 100 and the red, green, and blue color filters 210R, 210G, and 210B. As shown in FIG. 1, the red, green, and blue color filters 210R, 210G, and 210B may be disposed on an encapsulation substrate 200.

The light-shielding layers 220 may be disposed corresponding to locations between the pixel electrodes 120R, 120G, and 120B. The light-shielding layers 220 may be used to define sub-pixels. The light-shielding layers 220 may be a black matrix and may be formed of, for example, a black resin. Referring to FIG. 1, the light-shielding layers 220 may be disposed on portions of the encapsulation substrate 200 that are located between the red, green, and blue color filters 210R, 210G, and 210B. That is, the red, green, and blue color filters 210R, 210G, and 210B are disposed corresponding to the pixel electrodes 120R, 120G, and 120B, respectively, and the light-shielding layers 220 may be patterned between the red, green, and blue color filters 210R, 210G, and 210B. Since the light-shielding layers 220 are disposed corresponding to the locations between the pixel electrodes 120R, 120G, and 120B, the reflection of external light is reduced. As a result, a contrast ratio of the LCD apparatus may be improved.

The light sources 500 are capable of irradiating light onto the display devices. The light guide panel 400 is configured to transmit light emitted by the light sources 500 to the display devices. The light guide panel 400 and the light sources 500 may be referred to as back light units (BLUs). Light emitted by the BLUs enters the display devices and reaches the red, green, and blue color filters 210R, 210G, and 210B. Specifically, the BLUs may display a full-color image after light in a certain wavelength band among visible rays passes through the red, green, and blue color filters 210R, 210G, and 210B.

The light sources 500 may irradiate light onto the display devices from the second surface 100b of the substrate 100. Unlike an organic light-emitting display apparatus (OLED), the LCD apparatus does not emit light on its own. Accordingly, it is necessary to include the light sources 500 for irradiating light onto a display panel. The light sources 500 may be disposed on a lower surface of the light guide panel 400 opposite to a surface on which the substrate 100 is disposed. The light sources 500 on the lower surface of the light guide panel 400 may correspond to the respective light-shielding layers 220, which are disposed corresponding to the locations between the pixel electrodes 120R, 120G, and 120B. For the LCD apparatus to remain transparent while displaying an image thereon, the light sources 500 are thus disposed corresponding to the light-shielding layers 220 between the sub-pixels.

According to the present exemplary embodiment, the light sources 500 may include organic light-emitting diodes (OLEDs). As described above, OLEDs are capable of emitting light on its own, and thus, an image may be displayed on the LCD apparatus due to the light emitted by the OLEDs. As described above, since the light sources 500 including the OLEDs may be disposed corresponding to the respective light-shielding layers 220, the locations and the number of light sources 500 between the sub-pixels may be adjusted as desired, and thus, a constant light intensity may be irradiated onto the display devices.

The light guide panel 400 may be disposed between the light sources 500 and the substrate 100. The light guide panel 400 may be configured to transmit light emitted by the light sources 500 to the display devices. The light sources 500 are disposed on the lower surface of the light guide panel 400. Since the light emitted by the light sources 500 is transmitted to the display devices via the light guide panel 400, the light guide panel 400 is therefore transparent. In addition, the light guide panel 400 is transparent so that a user may see a background through a rear surface of the display apparatus, specifically, a rear surface of the BLU.

In some embodiments, the LCD apparatus may further include a first polarizer 150 disposed between the substrate 100 and the light guide panel 400 and a second polarizer 250 disposed on the encapsulation substrate 200. The first polarizer 150 may be disposed on the second surface 100b of the substrate 100. Specifically, the first polarizer 150 may be disposed on the entire second surface 100b of the substrate 100, and the second polarizer 250 may be disposed on an entire upper surface of the encapsulation substrate 200. Only portions of the light can pass through the first and second polarizers 150 and 250 in a predetermined direction (i.e., in a direction of a polarization axis). Thus, the first and second polarizers 150 and 250 may be optical devices having high light absorption.

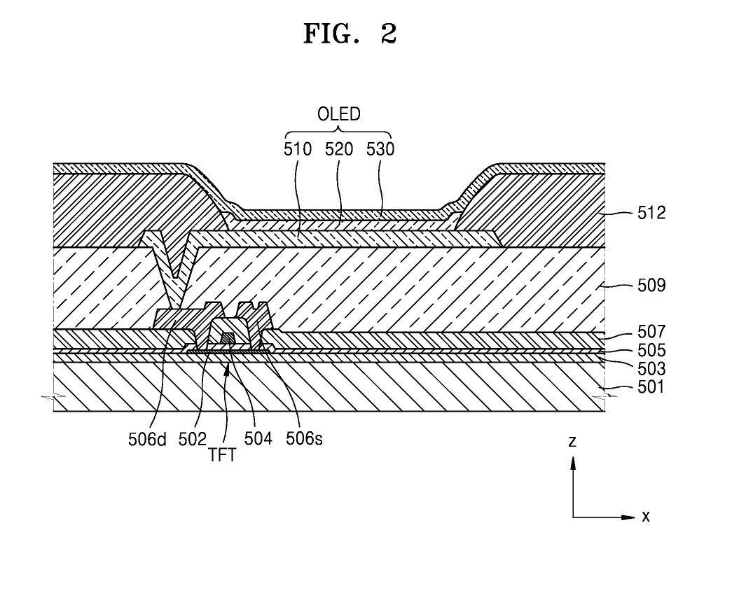

FIG. 2 is a schematic cross-sectional view of the light sources 500 of the LCD apparatus of FIG. 1.

As described above, each of the light sources 500 may include an organic light-emitting diode (OLED). The OLED may be transparent, but is not limited thereto. In some other embodiments, the OLED may be opaque. The light source 500 may include a first electrode 510, a second electrode 530, and an intermediate layer 520 disposed between the first electrode 510 and the second electrode 530. The structure of the light source 500 including the OLED will be described in detail as follows.

Referring to FIG. 2, a thin film transistor (TFT) may be disposed on a substrate 501. The TFT includes a semiconductor layer 502, a gate electrode 504, a source electrode 506s, and a drain electrode 506d. The semiconductor layer 502 may include amorphous silicon, poly silicon, or an organic semiconductor material. Next, the structure of the TFT will be described in detail as follows.

A buffer layer 503 is disposed on the substrate 501. The buffer layer 503 provides a planar surface on top of the substrate 501. The buffer layer 503 can also prevent impurities from entering the semiconductor layer 502. The buffer layer 503 may be formed of silicon oxide (SiOx), silicon nitride (SiNx), etc. The semiconductor layer 502 may be disposed on the buffer layer 503.

The gate electrode 504 is disposed on the semiconductor layer 502. The source electrode 506s is electrically connected to the drain electrode 506d when signals are applied to the gate electrode 504. The gate electrode 504 may be a single layer or a multi-layer structure comprising, for example, at least one of the following elements: aluminum (Al), platinum (Pt), palladium (Pd), silver (Ag), magnesium (Mg), gold (Au), nickel (Ni), neodymium (Nd), iridium (Ir), chromium (Cr), lithium (Li), calcium (Ca), molybdenum (Mo), titanium (Ti), tungsten (W), and copper (Cu). The material for the gate electrode 504 may be determined by taking into account the material's adhesion to an adjacent layer, surface flatness of stack layers, workability of the material, etc.

In some embodiments, a gate insulating layer 505 may be disposed between the semiconductor layer 502 and the gate electrode 504, so as to insulate the gate electrode 504 from the semiconductor layer 502. The gate insulating layer 505 may be formed of SiOx and/or SiNx.

An interlayer insulating layer 507 may be disposed on the gate electrode 504. The interlayer insulating layer 507 may be a single layer or a multi-layer structure comprising SiOx, SiNx, or the like.

The source electrode 506s and drain electrode 506d are disposed on the interlayer insulating layer 507. The source electrode 506s and drain electrode 506d are electrically connected to the semiconductor layer 502 via contact holes formed in the interlayer insulating layer 507 and the gate insulating layer 505. The source electrode 506s and drain electrode 506d may be a single layer or a multi-layer structure comprising, for example, at least one of the following elements: Al, Pt, Pd, Ag, Mg, Au, Ni, Nd, Ir, Cr, Li, Ca, Mo, Ti, W, and Cu. The material for the source electrode 506s and drain electrode 506d may be determined by taking into account the material's conductivity, etc.

In some embodiments (not illustrated), a protective layer may be disposed covering the TFT so as to protect the TFT. The protective layer may be formed of an inorganic material such as SiOx, SiNx, or silicon oxynitride (SiON). The protective layer may have a single-layer structure or a multilayer structure.

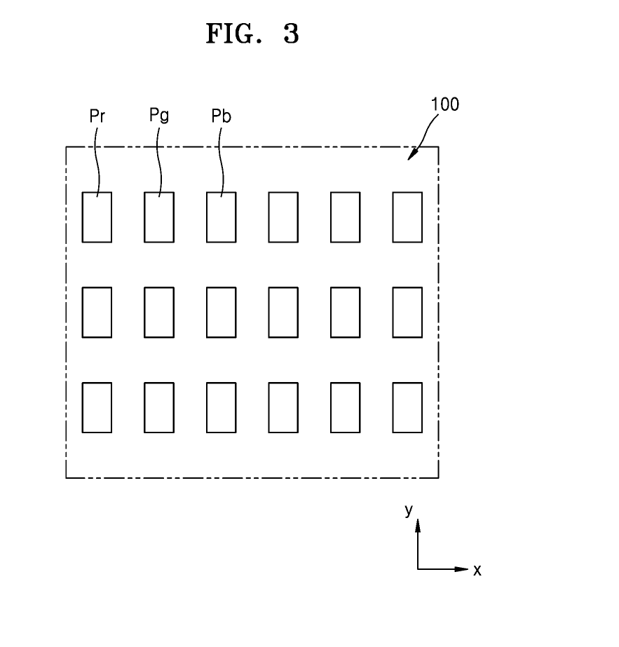

A planarization layer 509 may be disposed on the substrate 501. In some embodiments, the planarization layer 509 may be a planarization layer having the OLED thereon and provides an upper planar surface above the TFT. In some other embodiments, the planarization layer 509 may be a protective layer for protecting a lower surface of the TFT. The protective layer and planarization layer 509 may be formed of, for example, an acryl-based organic material, benzocyclobutene (BCB), or the like. In some embodiments, as shown in FIG. 3, the gate insulating layer 505, the interlayer insulating layer 507, the protective layer, and the planarization layer 509 may be formed on an entire surface of the substrate 501.

In some embodiments, a pixel-defining layer 512 may be disposed on the TFT. The pixel-defining layer 512 may be disposed on the planarization layer 509 and may have an opening exposing a central portion of the first electrode 510. Since the pixel-defining layer 512 is patterned to expose the central portion of the first electrode 510, the pixel-defining layer 512 thus defines a pixel area on the substrate 501.

The pixel-defining layer 512 may be formed of, for example, an organic material. The organic material may include, for example, an acryl-based polymer such as poly methyl methacrylate (PMMA), polystyrene (PS), a polymer derivative having a phenol group, an imide-based polymer, an aryl ether-based polymer, a fluorine-based polymer, a p-xylene-based polymer, a vinyl alcohol-based polymer, any combination thereof, or the like.

As shown in FIG. 2, the OLED may be disposed on the planarization layer 509. The OLED may include the first electrode 510, the intermediate layer 520 disposed on the first electrode 510 and including an emission layer, and the second electrode 530 covering the intermediate layer 520. In some embodiments, the intermediate layer 520 may be capable of emitting white light.

The first electrode 510 may be disposed on the planarization layer 509. In some embodiments, the planarization layer 509 has an opening exposing at least one of the source electrode 506s and the drain electrode 506d of the TFT The first electrode 510 may be electrically connected to the TFT by contacting any one of the source electrode 506s and the drain electrode 506d of the TFT via the opening.

The first electrode 510 may be formed of a transparent (or translucent) electrode or a reflective electrode. When the first electrode 510 is formed of a transparent (or translucent) electrode, the first electrode 510 may be formed of ITO, IZO, ZnO, In₂O₃, IGO, or AZO. When the first electrode 510 is formed of a reflective electrode, the first electrode 510 may have a reflective layer formed of Ag, Mg, Al, Pt, Pd, Au, Ni, Nd, Ir, Cr, any combination thereof, or the like, and a layer formed of ITO, IZO, ZnO, In₂O₃, indium gallium oxide (IGO), or aluminum zinc oxide (AZO). However, the inventive concept is not limited thereto. It is noted that the first electrode 510 may be formed of other types of materials, and may have a single layer or a multi-layer structure.

The intermediate layer 520 may be disposed in the pixel area defined by the pixel-defining layer 512. The intermediate layer 520 of the OLED includes the emission layer (EML). In addition to the EML, the intermediate layer 520 may have a single-layer structure or a multilayer structure comprising a hole injection layer (HIL), a hole transport layer (HTL), an electron transport layer (ETL), an electron injection layer (EIL), or the like. However, it should be noted that the intermediate layer 520 is not limited thereto and may be formed having various structures.

The intermediate layer 520 may be formed of a low molecular organic material or a polymer organic material. The HTL, the HIL, the ETL, and the EIL may be selectively stacked on the intermediate layer 520, and the EML may be disposed therebetween. A variety of layers may be stacked in different configurations depending on device requirements. In some embodiments, the HTL, HIL, ETL, and EIL may be integrated on an entire surface of the substrate 501, and the EML may be formed in each pixel through an inkjet printing process.

The intermediate layer 520 may be configured to emit white light. The intermediate layer 520 includes the EML that typically emit one of red (R), green (G), and blue (B) light. A method of emitting white light by the intermediate layer 520 need not be limited to any particular method. In some embodiments, for example, the white light may be generated by stacking a red emission layer, a green emission layer, and a blue emission layer, or by combining OLEDs respectively emitting red light, green light, and blue light.

The second electrode 530 may be formed on the entire surface of the substrate 501 opposite to the first electrode 510. The second electrode 530 is disposed covering the intermediate layer 520 including the EML. The second electrode 530 may be a transparent (or translucent) electrode or a reflective electrode.

When the second electrode 530 is a transparent (or translucent) electrode, the second electrode 530 may have a layer formed of metals having a small work function, that is, Li, Ca, LiF/Ca, LiF/Al, Al, Ag, Mg, or a combination thereof, and a transparent (or translucent) layer such as ITO, IZO, ZnO, or In₂O₃. When the second electrode 530 is a reflective electrode, the second electrode 530 may have a layer formed of Li, Ca, LiF/Ca, LiF/Al, Al, Ag, Mg, or a combination thereof. However, it should be noted that the structure and materials of the second electrode 530 need not be limited to the above, and may be different in other embodiments.

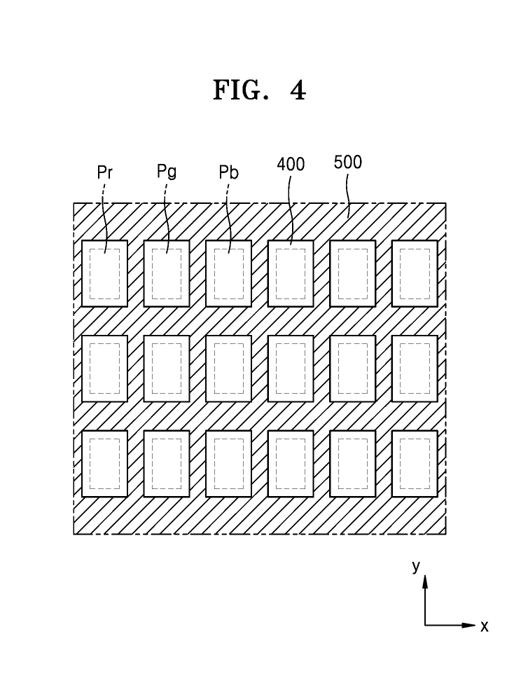

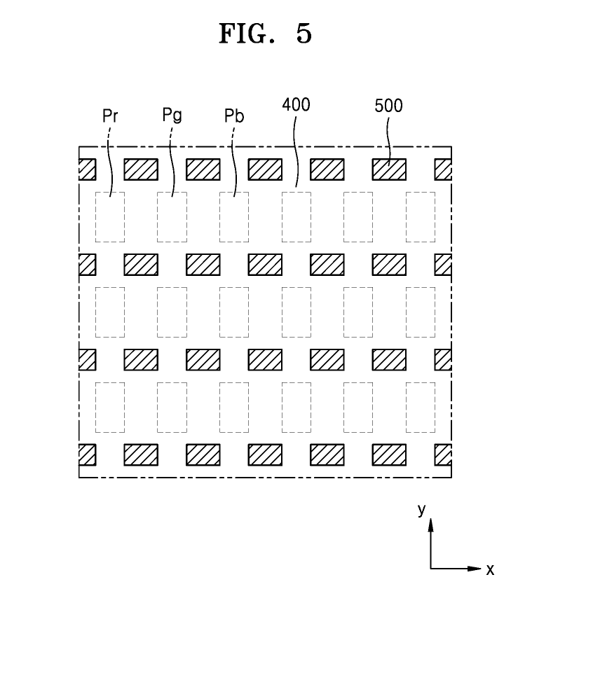

FIG. 3 is a schematic plan view of the LCD apparatus of FIG. 1, FIG. 4 is a schematic bottom view of the light guide panel 400 and the light sources 500 of the LCD apparatus of FIG. 3, and FIG. 5 is a schematic bottom view of the light guide panel 400 and the light sources 500 of an LCD apparatus according to another exemplary embodiment.

Referring to FIGS. 3 and 5, sub-pixels Pr, Pg, and Pb may be separated from each other. The sub-pixels Pr, Pg, and Pb may include a first sub-pixel Pr, a second sub-pixel Pg, and a third sub-pixel Pb configured to emit different colors of light. The first sub-pixel Pr may emit red light, the second sub-pixel Pg may emit green light, and the third sub-pixel Pb may emit blue light, but the inventive concept is not limited thereto. The aforementioned colors may be provided by the red, green, and blue color filters 210R, 210G, and 210B disposed corresponding to the respective sub-pixels Pr, Pg, and Pb, whereby the sub-pixels Pr, Pg, and Pb may be defined by the light-shielding layers 220. In some embodiments, the aforementioned colors may be provided by a color conversion layer (not shown).

As shown in FIG. 4, the light sources 500 may be disposed between the sub-pixels Pr, Pg, and Pb, and may be patterned on locations corresponding to the light-shielding layers 220 in a mesh form. The sub-pixels Pr, Pg, and Pb are separated from one another by the light-shielding layers 220. As described above, the light sources 500 including the OLEDs may be disposed corresponding to the respective light-shielding layers 220. Since the locations and the number of light sources 500 disposed between the sub-pixels Pr, Pg, and Pb may be adjusted as desired, a constant light intensity may be irradiated onto the sub-pixels Pr, Pg, and Pb.

Referring to FIG. 5, the light sources 500 may be disposed between the sub-pixels Pr, Pg, and Pb, and may be patterned on locations corresponding to the light-shielding layers 220 in an island form. Although not illustrated in FIG. 5, wires may be further formed connecting the light sources 500. The wires are separated from one another between the sub-pixels Pr, Pg, and Pb in an island form. It should be noted that the arrangement of the light sources 500 may be varied in different ways.

As shown in FIGS. 1, 4 and 5, the sub-pixels Pr, Pg, and Pb may be separated from one another by the light-shielding layers 220. That is, the light-shielding layers 220 may be disposed on locations corresponding to respective portions between the sub-pixels Pr, Pg, and Pb. The light sources 500 may be patterned on locations corresponding to the light-shielding layers 220 in a mesh or island form. An area of each light source 500 may be less than or equal to an area of each light-shielding layer 220. Since the LCD apparatus according to the present exemplary embodiment is a see-through LCD apparatus, the area of each light source 500 should be less than or equal to an area of each light-shielding layer 220 disposed between the sub-pixels Pr, Pg, and Pb. As a result, the LCD apparatus may remain transparent and display an image.

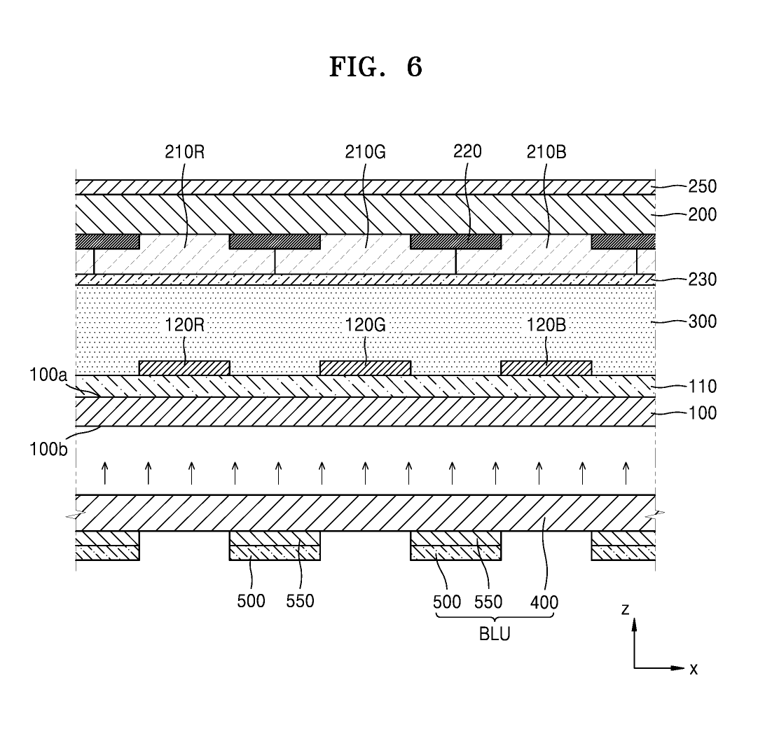

FIG. 6 is a schematic cross-sectional view of an LCD apparatus according to another exemplary embodiment. The structure of the BLUs in the LCD apparatus of FIG. 6 is different from the structure of the BLUs in the LCD apparatus of FIG. 1.

Referring to FIG. 6, the LCD apparatus includes a substrate 100, a plurality of pixel electrodes 120R, 120G, and 120B, a plurality of light-shielding layers 220, and a plurality of BLUs. The BLUs include a light guide panel 400, a plurality of light sources 500, and a plurality of polarizers 550 disposed between the light guide panel 400 and the light sources 500.

The substrate 100 may have a first surface 100a and a second surface 100b opposite to the first surface 100a. The substrate 100 is transparent and may be a glass substrate or a substrate including a polymer such as polyimide.

A plurality of display devices are disposed on the first surface 100a of the substrate 100. As shown in FIG. 6, the display devices may be liquid crystals filled with a liquid crystal 300 and disposed between the pixel electrodes 120R, 120G, and 120B and a common electrode 230. The pixel electrodes 120R, 120G, and 120B and the common electrode 230 may include transparent materials such as ITO, IZO, ZnO, or In₂O₃ which impart transparency characteristics. The pixel electrodes 120R, 120G, and 120B may be electrically connected to a plurality of TFTs. Accordingly, a TFT layer 110 may be disposed between the substrate 100 and the pixel electrodes 120R, 120G, and 120B.

It should be noted that the embodiment of FIG. 6 may be modified in different ways. For example, in some embodiments, an alignment layer may be further disposed on the pixel electrodes 120R, 120G, and 120B or the common electrode 230.

Colors filters 210R, 210G, and 210B may be disposed opposite to the substrate 100 such that the pixel electrodes 120R, 120G, and 120B are disposed therebetween. The red, green, and blue color filters 210R, 210G, and 210B may correspond to the pixel electrodes 120R, 120G, and 120B, respectively. That is, the red color filter 210R corresponds to the pixel electrode 120R having a red sub-pixel, the green color filter 210G corresponds to the pixel electrode 120G having a green sub-pixel, and the blue color filter 210B corresponds to the pixel electrode 120B having a blue sub-pixel. Accordingly, the display devices are disposed between the substrate 100 and the red, green, and blue color filters 210R, 210G, and 210B. The red, green, and blue color filters 210R, 210G, and 210B may be disposed on an encapsulation substrate 200.

The light-shielding layers 220 may be disposed corresponding to locations between the pixel electrodes 120R, 120G, and 120B. Specifically, the light-shielding layers 220 are disposed on portions of the encapsulation substrate 200 that are located between the pixel electrodes 120R, 120G, and 120B such that the sub-pixels are separated from one another. The light-shielding layers 220 may be a black matrix and may be formed of, for example, a black resin. Referring to FIG. 6, the light-shielding layers 220 may be disposed on the encapsulation substrate 200 between the red, green, and blue color filters 210R, 210G, and 210B. That is, the red, green, and blue color filters 210R, 210G, and 210B are disposed corresponding to the respective pixel electrodes 120R, 120G, and 120B, and the light-shielding layers 220 may be patterned between the red, green, and blue color filters 210R, 210G, and 210B. Since the light-shielding layers 220 are disposed corresponding to the locations between the pixel electrodes 120R, 120G, and 120B, the reflection of external light may be reduced. As a result, a contrast ratio may be improved.

The light sources 500 are capable of irradiating light onto the display devices. The light guide panel 400 is configured to transmit light emitted by the light sources 500 to the display devices. The light guide panel 400 and the light sources 500 may be referred to as BLUs. The light emitted by the BLUs enters the display devices and reaches the red, green, and blue color filters 210R, 210G, and 210B. The BLUs may display a full-color image when light in a certain wavelength band from among visible rays passes through the red, green, and blue color filters 210R, 210G, and 210B.

The light sources 500 may irradiate light onto the display devices from the second surface 100b of the substrate 100. Unlike an organic light-emitting display apparatus, the LCD apparatus does not emit light on its own. Accordingly, it is necessary to include the light sources 500 for irradiating light onto a lower portion of the substrate 100. The light sources 500 may be disposed on a lower surface of the light guide panel 400. Specifically, the light sources 500 may be disposed on the lower surface of the light guide panel 400 corresponding to the respective light-shielding layers 220, which are in turn disposed corresponding to the locations between the pixel electrodes 120R, 120G, and 120B. Since the LCD apparatus according to the present exemplary embodiment is a transparent LCD apparatus, the light sources 500 are thus disposed corresponding to the light-shielding layers 220 between the sub-pixels. Accordingly, the LCD apparatus may remain transparent and display an image.

According to the present exemplary embodiment, the light sources 500 may include OLEDs. As described above, the OLEDs are capable of emitting light on their own, and thus, an image may be displayed on the LCD apparatus due to the light emitted by the OLEDs. As described above, since the light sources 500 including the OLEDs may be disposed corresponding to the respective light-shielding layers 220, the locations and the number of light sources 500 between the sub-pixels may be adjusted as desired, and thus, a constant light intensity may be irradiated onto the display devices.

The light guide panel 400 may be disposed between the light sources 500 and the substrate 100. The light guide panel 400 may be configured to transmit light emitted by the light sources 500 to the display devices. The light sources 500 are disposed on the lower surface of the light guide panel 400. Since the light emitted by the light sources 500 is transmitted to the display devices via the light guide panel 400, the light guide panel 400 has to be transparent. Also, the light guide panel 400 is transparent so that a user may see a background through a rear surface of a display apparatus, specifically, a rear surface of the BLU.

Meanwhile, the LCD apparatus may further include a first polarizer 550 disposed between the substrate 100 and the light guide panel 400, and a second polarizer 250 disposed on the encapsulation substrate 200. The first polarizer 550 may be disposed on the second surface 100b of the substrate 100. The first polarizer 550 may be disposed on the entire second surface 100b of the substrate 100, and the second polarizer 250 may be disposed on an entire upper surface of the encapsulation substrate 200. Only portions of the light irradiated onto the first and second polarizers 550 and 250 can pass through in a predetermined direction (i.e., a direction of a polarization axis). Thus, the first and second polarizers 550 and 250 may be optical devices having high light absorption.

The first polarizer 550 may be patterned corresponding to the light sources 500. As previously described with reference to FIGS. 4 and 5, the light sources 500 may be patterned on locations corresponding to the light-shielding layers 220 in various forms such as a mesh form or an island form, and the first polarizer 550 may be patterned to correspond to the light sources 500. In the embodiment of FIG. 6, the first polarizer 550 may be a wire-grid polarizer (WGP) for improving the transmittance of a display panel. The WGP may be an array in which fine metal wires are regularly arranged parallel to one another. The WGP performs the same functions as a conventional polarizer. However, the materials for forming the WGP are not oriented, and the metal wires are disposed at intervals that are less than the wavelengths of incident light, and thus, the WGP may be easily patterned. The transmittance of the display panel may be improved by disposing the first polarizer 550 formed of the WGP on locations corresponding to the light sources 500.

An LCD apparatus capable of displaying an image at a constant light intensity has been disclosed in the above exemplary embodiments.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A liquid crystal display (LCD) apparatus comprising:
a substrate comprising a first surface and a second surface opposite to the first surface;
a plurality of pixel electrodes disposed on the first surface of the substrate;
a plurality of light-shielding layers disposed corresponding to first locations between the pixel electrodes;
a plurality of light sources corresponding to the light-shielding layers, wherein the light sources are configured to irradiate light onto the second surface of the substrate; and
a transparent light guide panel disposed between the light sources and the substrate.

2. The LCD apparatus of claim 1, wherein each of the light sources comprises an organic light-emitting diode (OLED).

3. The LCD apparatus of claim 2, wherein the OLED comprises:
a first electrode;
a second electrode; and
an intermediate layer disposed between the first electrode and the second electrode, wherein the intermediate layer is configured to emit white light.

4. The LCD apparatus of claim 1, further comprising a plurality of color filters disposed opposite to the substrate, wherein the pixel electrodes are disposed between the color filters and the substrate,
and wherein the light-shielding layers are disposed between the color filters.

5. The LCD apparatus of claim 4, wherein an area of each of the light sources is less than or equal to an area of each of the light-shielding layers.

6. The LCD apparatus of claim 4, wherein the light sources are disposed on second locations corresponding to the light-shielding layers in a mesh form.

7. The LCD apparatus of claim 4, wherein the light sources are disposed on second locations corresponding to the light-shielding layers in an island form.

8. The LCD apparatus of claim 1, further comprising a polarizer disposed between the substrate and the light guide panel.

9. The LCD apparatus of claim 1, further comprising a polarizer disposed between the light guide panel and the light sources,
wherein the polarizer is patterned corresponding to the light sources.

10. The LCD apparatus of claim 9, wherein the polarizer is a wire-grid polarizer (WGP).

11. The LCD apparatus of claim 9, wherein the light guide panel and the light sources are flexible.
